(19) United States
(12) Patent Application Publication
(10) Pub. No.: US 2013/0259216 A1
(43) Pub. Date: Oct. 3, 2013

(54) Social interaction system between anonymous users

(71) Applicant: FOUGESIA LIMITED, Moscow (RU)

(72) Inventor: Grachik Adzhamyan, Moscow (RU)

(73) Assignee: Fougesia Limited, Moscow (RU)

(21) Appl. No.: 13/853,787

(22) Filed: Mar. 29, 2013

Related U.S. Application Data
(60) Provisional application No. 61/618,682, filed on Mar. 31, 2012.

(51) Int. Cl. H04M 3/42

(52) U.S. Cl. CPC H04M 3/42229
USPC 379/201.02

(57) ABSTRACT

This invention relates to the field of data and voice communication. In particular, the invention relates to a system for making connections between two or more anonymous subscribers in order to initiate communication and exchange. The invention also relates to a method of using such system, preferably by means of internet interface and a communication based exchange. A system for making connections between two or more subscribers, preferably anonymously, is provided that can be used to replace impersonal and detached software generated services currently available on a telephony fixed line network, a cellular network, a VoIP network or a combination of these networks. While the described system is not limited to a particular purpose, it can be used by two or more subscribers to initiate a voice communication with the goal of (1) reminding, (2) waking-up, (3) dating, (4) socializing, (5) greetings, (6) congratulating, (7) note taking, etc.

### CROSS-REFERENCE TO A RELATED APPLICATION

This application claims the benefit under 35 U.S.C. 119(e) of U.S. Provisional Application No. 61/618,682 filed on Mar. 31, 2012, the disclosure of which is incorporated herein in its entirety.

### FIELD OF THE INVENTION

This invention relates to the field of data and voice communication. In particular, the invention relates to a system for making connections between two or more anonymous users/subscribers in order to initiate communication and exchange. The system allow to make anonymous connections between two or more users/subscribers via the automatic telephone exchanges through one or more digital and/or analogue networks. Depending on the service request, the system can connect users/subscribers independently or when initiated by one or more users/subscribers. The invention also relates to a method of using such system, preferably by means of internet interface and a communication based exchange.

### BACKGROUND

People often become acquainted due to their immediate environment, i.e. school, college, bar, work and so forth and/or due to contact through mutual friends. The most prevalent factor leading to the majority of human contacts is the existence of such link or situation/circumstance, either directly or indirectly.

However, as the popularity of the Internet has increased, so has the prevalence of social networking websites and applications. Generally speaking, a social network refers to an application or service that facilitates the building of online communities of people who share interests and activities, or who are interested in exploring the interests and activities of others.

Many social networks are web-based and provide a variety of ways for users to interact, such as e-mail and instant messaging services, e.g., Facebook (http://www.facebook.com). However, all of the social network applications are directed to enhancing personal experience when interacting with a set of known friends or with a computer.

There is therefore a need for a system where users can still interact with a wide range of other individuals yet maintain anonymity and control.

### SUMMARY

A system for making connections between two or more subscribers, preferably anonymously, is provided that can be used to replace impersonal and detached software generated services currently available on a telephony fixed line network, a cellular network, a VoIP network or a combination of these networks. While the described system is not limited to a particular purpose, it can be used by two or more subscribers to initiate a voice communication with the goal of (1) reminding, (2) waking-up, (3) dating, (4) socializing, (5) greetings, (6) congratulating, etc.

The system includes a telephone exchange, such as a private branch exchange (PBX), that connects telephone calls initiated from various extensions and ensures the transmission of the analog and/or digital data, e.g., conversation, alarm, user status, etc., a database, and a controller in communication with the database and the exchange. The extensions are not particularly limited and can be selected from any land line or wireless devices. Examples of such devices include landline telephones, mobile (cellular) telephones, computing devices that may be connected to a data link (e.g., RJ45, cellular, Wi-Fi, Bluetooth, etc.). The controller is configured to search based on any prescribed parameters, such as time, region, language, sex, age, interests, etc. the database of subscribers and when the subscriber that matches previously stipulated parameters is identified, the controller instructs the exchange to either initiate a call or connect the subscribers that have already being contacted.

In a preferred embodiment, the system functions as a “social alarm,” where at least one subscriber sets-up the time and date of the wake-up call preferably via an internet based application and subsequently can be woken up by another subscriber available at a prescribed time. The present invention also encompasses a method for initiating anonymous connections between two or more subscribers.

In one exemplary embodiment, the call is initiated by at least one subscriber to the system of present invention, who is ready to provide a wake-up service. The term “call” embodies both telephony based dial in and voice over IP initiated connection (e.g., Skype, Google Phone, etc.). The system performs a search from available subscribers who have previously requested service, for instance, a wake-up service. One of the functions of the system is to identify a proper subscriber before initiating a link between two subscribers. The main function of the system is to create a query to the database at the request of the exchange and search the list of subscribers who requested service with the most appropriate parameters applicable for the service, such as availability, time, sex, age, region, language, specific interests, and any other desired parameters that would best match two subscribers. Once the appropriate subscriber who requested service is identified, the system authorizes the exchange to connect two subscribers. Alternatively, if the subscriber is unavailable, the system initiates another search to identify another subscriber with the parameters that best match two subscribers until the number of attempts is exhausted.

In another exemplary embodiment, the system creates a query to a database to identify subscribers that requested a service (e.g., alarm/wakeup) at the current time window. The subscribers can be both requesters of service or a provider and a requester. The term “requester” means a subscriber who has requested service. The term “provider” means a subscriber who is providing the service. If the subscribers are both requesters, the system identifies the most appropriate parameters that would best match the two requesters before authorizing the connection between them. The parameters employed by the system are not particularly limited and can be selected, for example, from sex, age, region, language, interests, astrological signs, or religion. Once the appropriate subscribers who requested the service have been matched, the system instructs the exchange to initiate a call either to both subscribers simultaneously (parallel) or to call one subscriber after the other (serial) once the first subscriber responds.

Alternatively, if the subscribers are at least one provider and at least one requester, the system preferably first calls the provider. Once the provider responds, the system identifies the most appropriate requester that would best match the provider. Once the appropriate requester has been identified within the prescribed time window, the system instructs the exchange to initiate a call to the requester and two subscribers can initiate a conversation.

In yet another exemplary embodiment, the call is initiated based on the number of subscribers participated in the connection, the purpose of the connection, the burden on the system, etc. Although, the invention is described primarily with reference to two subscribers, it is within the scope of this invention to have more than two subscribers participate in the call. For example, a provider can be connected with two or more requesters simultaneously, or two or more providers are connected with one requester, or a plurality of providers are connected with a plurality of requesters.

These and other characteristics of the system and method(s) of using such system will become more apparent from the following description and illustrative embodiments, which are described in detail with reference to the accompanying drawings. Similar elements in each figure are designated by like reference numbers and, hence, subsequent detailed descriptions of such elements have been omitted for brevity.

### BRIEF DESCRIPTION OF THE DRAWINGS

FIG. 1 is a flowchart diagram illustrating the functional steps of one exemplary embodiment of the disclosed system.

FIG. 2 is a flowchart diagram illustrating the functional steps of another exemplary embodiment of the disclosed system.

FIG. 3 is a flowchart diagram illustrating the functional steps of one exemplary system based on serial configuration.

FIG. 4 is a flowchart diagram illustrating the functional steps of one exemplary system configured for outgoing calls only.

FIG. 5 is a flowchart diagram illustrating the functional steps of one exemplary system based on parallel configuration.

FIG. 6 is a flowchart diagram illustrating the functional steps of one exemplary system configured in a backup automated mode.

### DETAILED DESCRIPTION

As will be described in detail below with respect to the Figures, a preferred embodiment of the invention includes a system and a method of initiating social interaction. In contrast to all known types of systems, e.g., wake-up service, the system of the present invention is configured to connect two or more (human) subscribers anonymously based parameters or preferences that the subscribers have identified prior to the initiation of the connection. In a preferred embodiment, the system is configured to “socialize the alarm function.” In particular, a social network functionality that allows communication with others yet providing anonymity and control. The parameters evaluated by the system are not particularly limited and may include one or more of the parameters attributed to sex, age, location of the subscriber, language, interests, religion, political views, education, etc. Alternatively, the connection can be established based on other less individually specific parameters such as the number of connections, the purpose of the connection, the burden on the system, etc.

Broadly, the system can have an exchange, a database and a controller. The exchange is a device or a combination of devices that are configured to connect telephone calls initiated through a land line or wirelessly based on a switching algorithm known in the art. The connection and switching can be done by an analog, digital, or a combination of two. One exemplary exchange is a private branch exchange (PBX, also known as PABX or EPABX). The PBX can be configured to communicate with other components of the system using an extendable markup language (XML), simple object access protocol (SOAP), JAVA, or other computer languages known in the art.

The database is an organized collection of data, usually in digital form. The data are typically organized by the subscribers, their contribution e.g., requester, provider, both, parameters, e.g., sex, age, region, language, etc., and preferences in a way that supports processes requiring this information. For example, a closely matching a provider with a requester. It is to be understood, that the term “database” is applied to the data and their supporting data structures including a database management system (DBMS). A general-purpose DBMS include Oracle, IBM DB2, Microsoft SQL Server, PostgreSQL, MySQL and SQLite. Although, any type of communication can be used to communicate with the database, the most widely supported database language is SQL, which combines the roles of both data definition language (DDL), data manipulation (DML), and a query language.

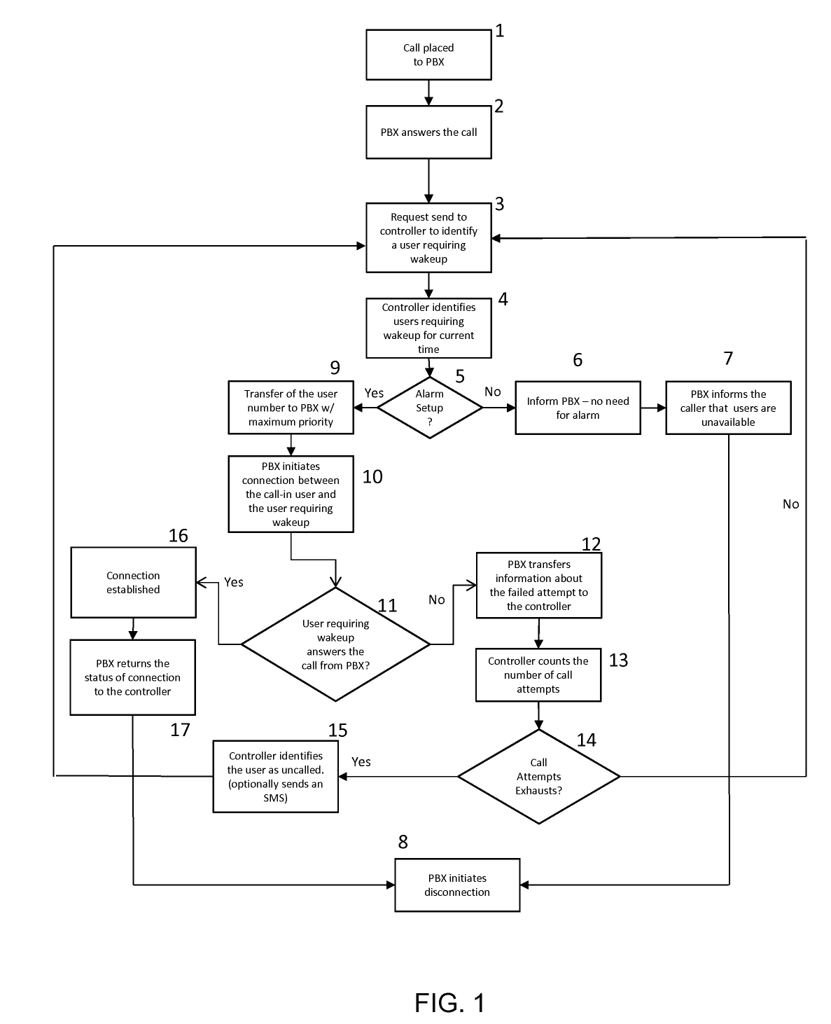

The controller is essentially a processing unit, such as a computer. The controller can be configured to have multiple functions, such as searching, processing the data through a decision matrix, and regulating other interconnected components of the system, e.g., controlling the exchange. The search engine aspect of the controller is configured to search for text-based content in databases (XML, CSV, etc.) based on complex queries (with multiple logical or string matching arguments). Once the match is located, the controller goes through a decision matrix (see FIG. 1-6) and upon the successful completion of the decision matrix, instructs the exchange to connect the predetermined subscribers. The system can also have an interface for subscribers to submit their data and requests. Preferably, the interface is web-based (e.g., interactive website), text messaging-based or telephone-based.

For example, one exemplary system is termed “social alarm” which relies on anonymous subscribers waking up each other and providing an opportunity for lively discussion. Yet, the system maintains complete anonymity of the subscribers because the system acts as a third party intermediary between the subscribers. In such a system, one subscriber who is interested in being woke up by another subscriber, inputs his or her information into the system by means of an interface, such as, but not limited to, web based interface, email, text-message (e.g., SMS), voicemail, interactive computer based telephone operator, or a person acting on behalf of the system. The information may include the desired time for the alarm with or without providing a preference in the subscriber who will provide the wake-up service. The preferences attributed to the subscriber are not particularly limited and can be the preference for whether the subscriber desires to be woken up by a male or female from a particular region of particular age. The system reaches its optimal usability once a sufficient number of subscribers join the service.

At the time of the alarm, in one embodiment, at least one subscriber contacts the system. The subscriber may be required to input his or her unique code that preferably identifies the subscriber as a provider or the system recognizes the telephone number associated with the subscriber. The system performs a search from available subscribers who have previously requested a wake-up service (requesters). One of the functions of the system is to identify a proper requester before initiating a link between the provider and the requester. The main function of which is to create a query to the database at the request of the controller and search the list of the requesters with the most appropriate parameters, such as available requesters for the prescribed/current time window, but also sex, age, a region, language, interests, etc. that would best match the provider. For example, if the provider calls into the system at 7:56 am. The system identifies an appropriate time window that it will consider. The appropriate time window can be less than a minute, 1, 2, 3, 4, or 5 minutes. In some circumstances, the time window can be longer. Therefore, if the time window is set to 5 minutes, the system will consider all the subscribers who requested a wake-up call between 7:56 and 8:01 am. The subscriber with an earlier wake-up time within the prescribed window has the priority. In certain embodiments, the identified subscribers within the time window will be further analyzed based on additional parameters. For instance, if the subscriber requested to be woken up by a female, but the provider is a male, the controller will bypass this subscriber until the best match is identified within the prescribed time window. Once the appropriate requester is identified, the controller instructs the exchange to connect the provider with the requester. Alternatively, if the requester is unavailable, the system looks to the next available requester based on the most appropriate parameters.

In one exemplary embodiment, FIG. 1 illustrates a simplified schematic block diagram which shows the general configuration of the system and the interaction between the subscribers. After receiving information on the availability of subscribers who require a wake-up call (i.e., requesters), for example, by SMS, a voicemail, or an email, as shown in FIG. 1, the subscriber (i.e., provider) calls the system or specifically, the PBX on the number provided (1). After receiving the signal, the PBX accepts the call (2) and sends a request (3) to the controller to identify available subscribers who require a wake up service at the present time. Optionally, the PBX also sends the controller the subscriber's phone number and the information that the subscriber has provided. If clarification is necessary, the controller instructs the PBX to send a request to the subscriber before submitting a query to the database to check for previously installed alarms (4), which have not yet been linked to other subscribers. The clarification may be necessary if the subscriber who requested a wake up service has a preference. Some subscribers may prefer to be contacted by individuals of the opposite sex, same sex, similar age, regional background, interests (music, movies, sports, books and activities) and some subscribers may have no specific preferences.

To ensure adequate accuracy, the controller implements a query to the database (4), which verifies the presence of subscribers with a status “needs wake-up.” After checking the availability of subscribers in a database, the controller obtains the information (5). Even if the subscriber who called in was informed about the availability of subscribers with status “needs wake-up” the system confirms again whether a subscriber with a status “needs wake-up” is still available. For example, a situation may arise where a connection was not completed between a subscriber who called in earlier and another subscriber who requested a wake-up call. In such a situation (or situations where a person has no information on whether there are subscribers who need to wake up), the system checks the database again with the established time period for the alarm.

If subscribers having status “needs wake-up” were not found for the present time frame, the controller instructs the PBX that no alarm is needed (6) at this time and the subscriber is notified, for example, with a prerecorded message (7), that currently there are no subscribers to connect to and prompt the provider to call back later. Alternatively, the system may offer the provider an opportunity to be called back later by the system when the requester with a status “needs wake-up” is identified that matches the provider and/or requester preference. In yet another alternative, the system may offer the provider different mode of notification such as by an email, SMS, or a web interface. Additional interaction with the provider is desirable in order to avoid loss of interest in the service and ensures its efficiency. After the transfer of information (7), the controller instructs the PBX to initiate a disconnection (8).

Alternatively, if subscribers having status “needs wake-up” were found for the present time frame and the preferences are matched, the controller identifies the requester with the highest priority and instructs the PBX to initiate a call to the requester (9). PBX calls the requester and checks whether the call is accepted by the requester (10). If the PBX cannot establish a connection with the requester (11), the PBX informs the system of the failed attempt (12), which is counted (13) and verified until the number of the prescribed attempts is exhausted (14). Despite the envisioned purpose of the social alarm to wake up subscribers by other subscribers anonymously, there is always a chance that the subscriber already woke up prior to the initiated contact by the system or the subscriber changed his/her mind and refuses to respond. At this point, if the number of retries is exhausted, the subscriber is assigned a status of “unavailable” and send a notification that the service made an attempt to wake the subscriber up, but it was unsuccessful (15). The controller returns and submits another request to the database (3) to identify available subscribers who require a wake up service at the present time having a status “needs wake-up.” The subscribers with a status “unavailable” are taken out of the pool of available subscribers. The system repeats the cycle until the connection is established within the prescribed time window.

If, however, the requester answers the call (11), the controller instructs the PBX to establish a connection (16), after which the subscribers (provider and requester) communicate for a period of time (17). After completing the call, the PBX returns the status of the subscriber “woken up” and any other information such as a call duration to the controller that inputs the date into the database. After the completion of the call, PBX initiates disconnection (8).

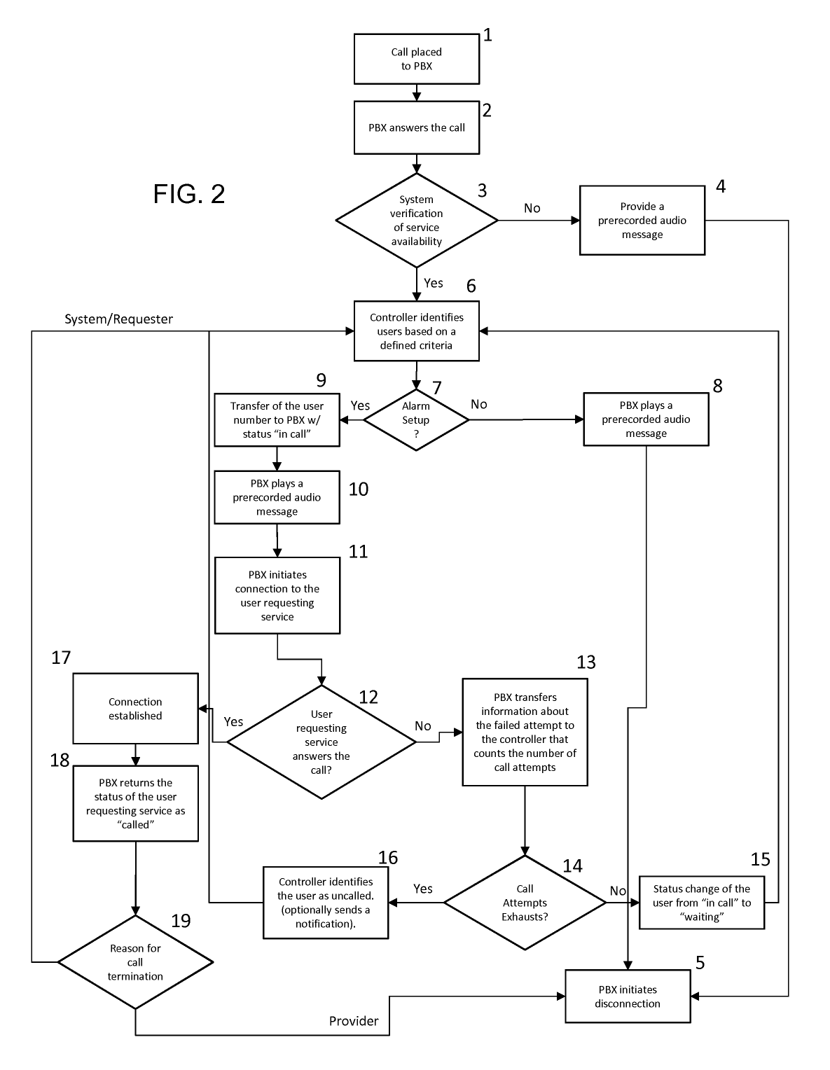

In another embodiment illustrated in FIG. 2, a subscriber/user (provider) who agreed to provide service for another subscriber/user calls (requester) the system at a given time to determine whether a service is requested. Alternatively, the provider can also check by means of a web site, a mobile application, an application for the internet-ready TVs or DVD/blue-ray playback devices, or other similar means. After receiving the information about the ordered services availability (i.e., the period of service request validity has not expired), the provider makes a call (1) by means of a mobile phone, a PC, a handheld computer (via SIP), a radio, or other similar means of communication. PBX receives the call (2) and either independently or through another system verifies the service availability/allowance by the given provider (3). If the service rendering is impossible, the PBX plays back the appropriate message to the provider (4). Then the system initializes the disconnection (5). If the service rendering is possible for the provider, the system selects the service set by the requester, which complies with the predefined criteria (6).

The verification is implemented on the availability of the service, ordered by the requester for the provider (7). If the system does not detect the services, set by the requester, complying with criteria for the provider, then the PBX plays back the appropriate voice message for the provider (8). After that, the PBX initializes the disconnection (5). If there are services requested, complying with the criteria set for the provider, then the system changes the status of the ordered service to “in call” and transmits to PBX the number of the user, which has ordered the service (requester) (9). The PBX plays back the appropriate voice message to the provider (10).

After the requester selection and its number transmission to PBX, the call to the requester is made (11). The call is verified, i.e., whether the call from PBX has been received by the requester (12). In case it has not occurred, the system reduces the quantity of call attempts by one (13) and verifies whether all call attempts have been exhausted for a particular requester (14) If the call attempts to the requester have not been depleted, the system changes the status of the ordered service from “in call” to “waiting” (15) and keeps the requester as part of the selection for subsequent calls by this or another provider (6). If the number of attempts has been depleted, the system considers that service request has been completed and the status of the request is assigned “uncalled”. Optionally, an appropriate notification can be send to the requester (16). The system returns to the state of selection of the services ordered by the requester(s) for this particular provider (6).

If the requester received the call from PBX (12), the PBX establishes a connection between the requester and the provider (17). The service ordered by the requester is considered to be fulfilled, and the system changes the service status to “called” (18). Once the conversation terminates, the system verifies the reason for disconnection (19). If the disconnection has occurred due to the requester's initiative, or due to the system's action, then the system returns to the state of service selection ordered by the requester for the provider (6). In contrast, if the disconnection has occurred due to the provider's initiative, the PBX initializes the disconnection (5).

In yet another embodiment, the system initiates a call to a subscriber (provider) who agreed to wake up another subscriber (requester) with an installed the alarm at a given time. The installed alarm within the context of this application means the alarm setup on the system. This embodiment involves the use of at least two subscribers, but can be used by three or more. Specifically, the controller creates a query to a database to identify subscribers that requested a service (e.g., alarm/wakeup) at the current time window. The subscribers can be both requesters of service or a provider and a requester. If the subscribers are both requesters, the system identifies the most appropriate parameters, such as sex, age, region, language, interests, etc. that would best match between the two requesters. Once the appropriate requesters have been matched, the controller instructs the PBX to initiate a call either to both subscribers simultaneously (parallel) or to call in sequence (serial) after each subscriber responds. Alternatively, if the subscribers are a provider and a requester, the system preferably first calls the provider. Once the provider responds, the controller identifies the most appropriate requester that would best match the provider. Once the appropriate requester has been identified within the prescribed time window, the controller instructs the PBX to initiate a call to the requester.

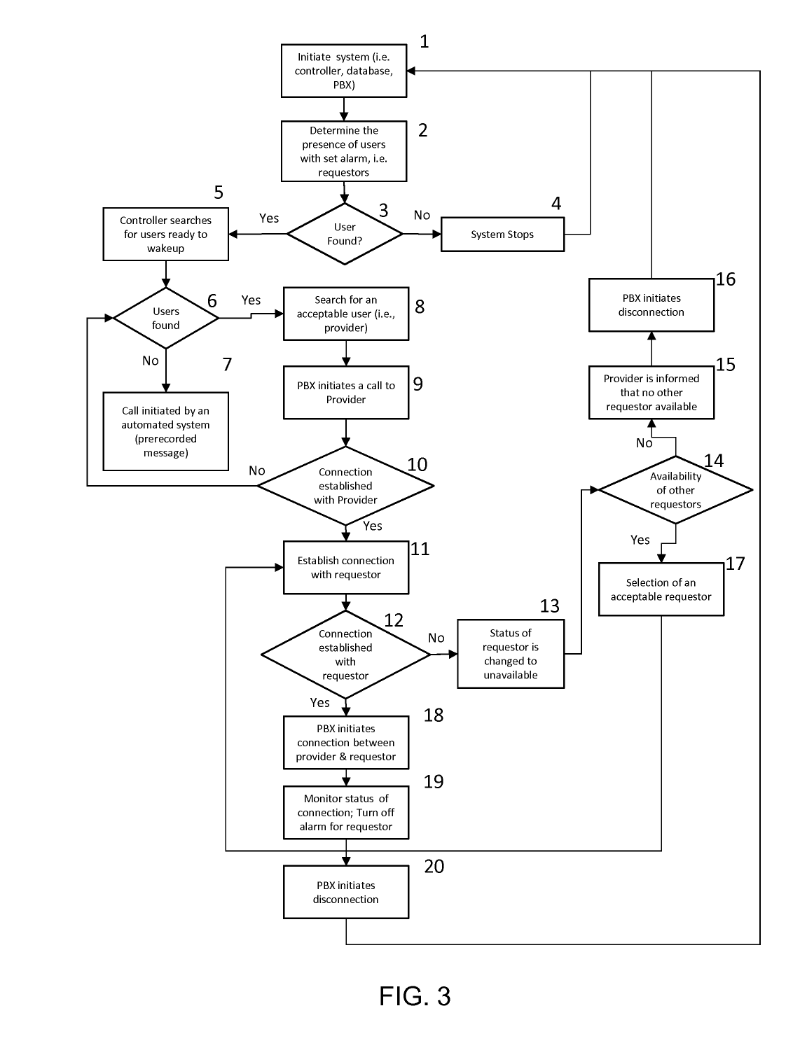

FIG. 3 is a simplified schematic block diagram which illustrates the general configuration of the system of this embodiment. Periodically, the controller starts searching for subscribers (1) listed in a database with a status “needs wake-up” (2). If during the search, the controller does not find a subscriber with a status “needs wake-up” for this time (3), the system finishes its work (4) and returns to its original state (1), waiting for the next round.

If during the search of the database the subscribers (requesters) with a status “needs wake-up” for this time were found (3), the controller submits another request to the database (5) in order to identify the subscribers (providers) who are ready to provide a wake-up service. If no provider is found (6), the controller instructs the PBX to call the requester in standalone mode. The requester with a status “needs wake-up” receives a prerecorded wakeup call (7). If the database contains one or more providers (6), the system selects the most appropriate provider (8), whose parameters are most suitable for the requester. After the provider is selected, the controller instructs the PBX to initiate a call to this provider (9).

After initialization, the connection is checked (10) to determine whether the provider answered the call. If the connection to the provider has not been established, the controller returns to step (6) in order to identify the next appropriate provider. If the connection to the provider has been established, the controller instructs the PBX to call the requester (11).

After initialization, the connection is checked (12) to determine whether the requester answered the call made by the PBX. If the connection has not been established, the controller changes the status of the requester to “unavailable” (13). Alternatively, the controller may instruct the PBX to call the same requester multiple times within a certain time window, e.g., 30 seconds, before changing the status of the requester. After changing the status of the requester to “unavailable,” the controller checks whether the database has additional requesters in the pool (14) at a given time interval. If an additional requester is found having the desired parameters (17), the controller instructs the PBX to establish a connection with that requester (11). The cycle repeats until the connection is established. Otherwise, the controller instructs the PBX to inform the provider that the wake us service is not required at this moment (15) Then the PBX initiates disconnection of the provider (16) and returns to a standby mode (1).

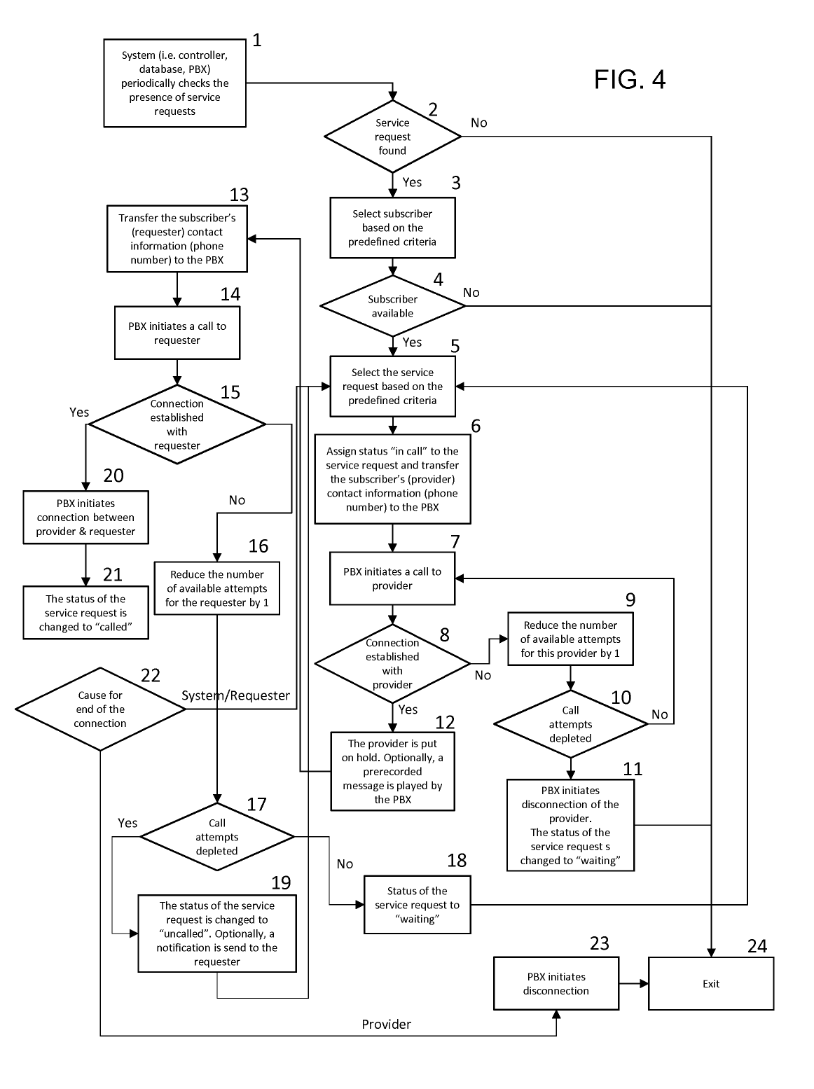

In one embodiment, the system is configured for the connection of two and more subscribers of the telephone, cellular and VoIP networks. The given system offers the initialization of calls from the PBX side, i.e. both subscribers are on the receiving end of the call. This embodiment requires at least two users to establish the connection. However, it is possible to have three and more users. FIG. 4 is a simplified schematic block diagram which illustrates the general configuration of the system of this embodiment.

Periodically, the system checks and verifies the existence of services (2). If there are no ordered services, the system ends the current cycle (24). If the ordered services are present, the system chooses a subscriber/provider based on a predefined criteria (3). The availability of subscriber is checked (4). If the subscriber is not found, then the system ends the current cycle (24). If the subscriber is found, then the system selects the service ordered by the requester based on said criteria (6).

Status “in call” is assigned to the service and the number of the subscriber (provider) is transmitted to PBX (6). PBX makes the call to subscriber (7). The system verifies whether subscriber has answered the call initiated by the PBX (8). If the subscriber has not answered, the system subtracts the number of dial attempts to the subscriber (9) and verifies whether all of the attempts have been exhausted for dialing to the subscriber (10). If not all attempts were exhausted, the system requests the PBX to make another call to the subscriber (7). If the attempts are depleted, then the system switches off the subscription of the subscriber and changes the status of the service from “in call” to “waiting”. After that the system ends the cycle (24).

If during the verification of the subscriber (provider) answer the PBX call (8), the system plays back the appropriate message (12). After that, the number of the user who requested the service (requester) is transmitted to the PBX (13). PBX makes the call to this subscriber (14) and the system verifies whether the call has been received. (15). If it has not occurred, then the system reduces the number of attempts allowed for each subscriber by one (16) and verifies whether all attempts have been used up (17). If the call attempts have not been depleted, then the system changes the status of the ordered service from “in call” to “waiting” (18) and returns into the selection of service state based on the predefined criteria suitable for the provider (5). If the call attempts have been depleted, then the system considers that the ordered service is performed and the status is changed to “uncalled” and, if requested an appropriate notification is sent to the requester (19). The system returns to the state of selection of the services. (5).

If the requester has received a call from PBX (15), the PBX connects both subscribers (20). The service ordered by the requester is considered to be fulfilled, and the system changes the service status to “called” (21). Once the conversation ends, the reason for the disconnection is verified (22). If the subscribers are disconnected due to the requesters initiative, or due to the system actions, the system returns into the service back into the state of selection. (5). If the subscribers are disconnected due to the initiative of the provider, then the connection ends (23), and the system exits from the cycle (24).

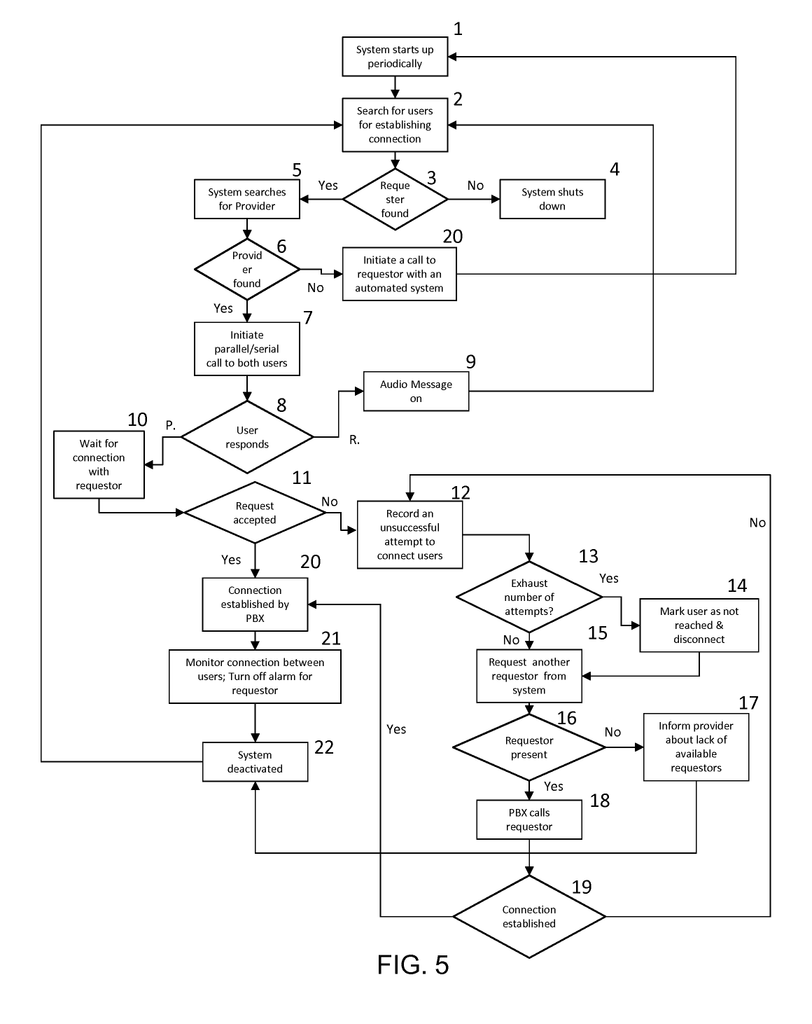

In the embodiment where the connection is established with the requester (12), the controller instructs the PBX to initiate a connection between two subscribers (the provider and the requester) (18). After the end of the conversation, the status of the requester is changed to “woken up” (19). The PBX initiates disconnection (20) and the system returns to a standby mode (1). FIG. 5 is a simplified schematic block diagram of another embodiment of the present invention. The primary difference between this embodiment and the embodiment described in FIG. 3 is the initialization process and the ability to make synchronous calls to two, three or more subscribers.

Periodically, the controller starts searching for subscribers (1) in order to identify subscribers (requesters) listed in a database with a status “needs wake-up” (2). If during the search, the controller does not find a requester with a status “needs wake-up” for this time (3), the system finishes its work (4) and, preferably, returns to its original standby state (1), waiting for the next startup.

If during the search of the database the requester with a status “needs wake-up” for this time was found (3), the controller submits another request to the database (5) in order to identify another subscriber (provider) (6). If the provider is not found at this time interval, the controller instructs the PBX to call the requester with a prerecorded message (20), after which the system returns to the standby mode (1).

If the database contains one or more providers (6), the system selects the most appropriate provider whose parameters are most suitable for the requester. After the provider is selected, the controller instructs the PBX to initiates a synchronous call to both subscribers (the provider and the requester) (7). In this embodiment, the algorithm of the system is dependent on who responds first to a synchronous call placed by the PBX (8). If the requester responds first, the system sends a message (9), which informs the requester that as requested this is his wakeup call. The reason behind this approach is to place the provider who answers afterwards into a standby mode while the system attempts to identify another requester (2).

If the provider responds first, then the system puts the provider into a standby mode (10). Afterwards, the controller checks whether the requester responds (11). If the requester does not respond to the PBX call, the status of this requester is changed to “unavailable.” Optionally, the controller may request that the PBX initiate multiple attempts to reach the requester (12) until either the time or the number of attempts has been exhausted (13). If all attempts are exhausted, the controller assigns the status to the requester “uncalled.” The requester is disconnected (14) and a controller submits a new request to the database to identify another requester (15).

If no other requesters are identified (16), the controller instructs the PBX to inform the provider in standby that no other requesters are presently available (17). The provider is disconnected and the system goes into hibernation mode (22). However, if another requester is identified (16), the controller instructs the PBX to attempt to reach this requester (18) and checks whether the connection is established (19). If the connection has been established, the controller instructs the PBX to connect both subscribers (20) and monitor their connection. The status of the requester is changed to “woken up” (21). After the call is completed, the system is goes into a hibernation mode (22). In the scenario where the connection with the requester is not established (19), the system returns back to step (12) and identifies the call as failed.

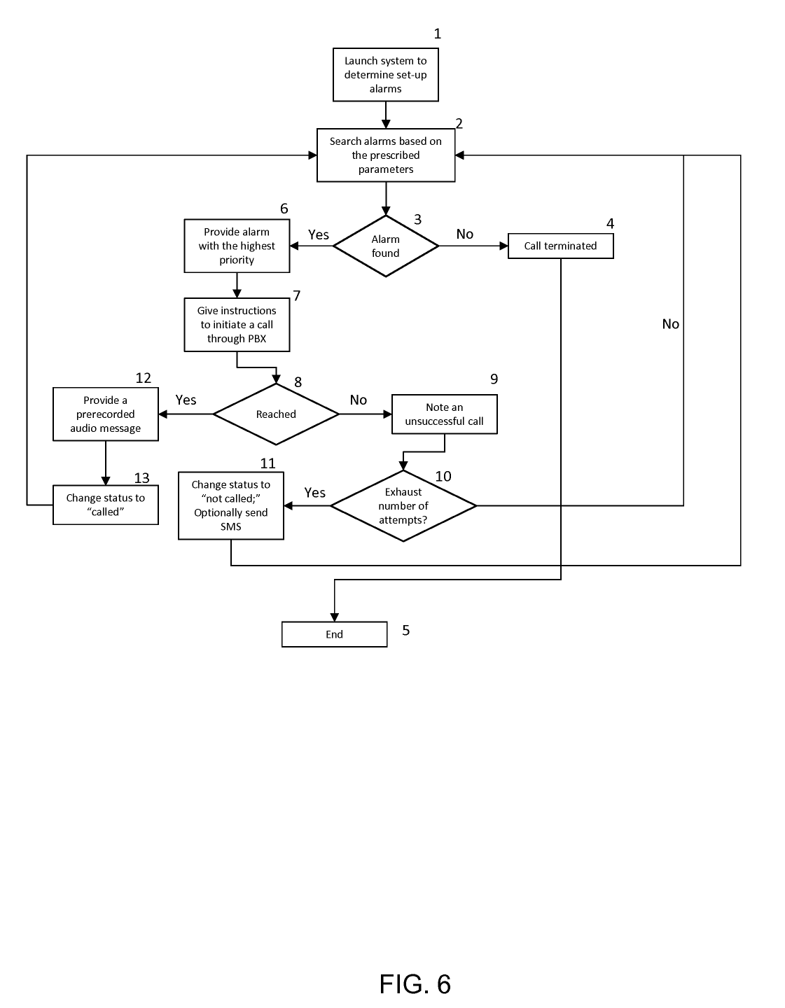

In yet another embodiment illustrated in FIG. 6, the reliability of the system can be improved by maintaining control over the calls made to the subscribers, preferably in a fully automated mode. The advantage of this embodiment is the reliability and assurance of service in case any subscriber who requested a wakeup service will not receive a requested call from another subscriber. In such scenario, the system independently initiates a call to each of the subscriber who requested a wakeup service. This scenario would typically arise when the number of subscribers did not reach a critical mass.

FIG. 6 is a simplified schematic block diagram which illustrates the general configuration of the system in “auto call” mode. Periodically, the controller performs a search (1) in the database to identify subscriber who requested a wakeup service (requesters) for a given time interval and prescribed parameters (2). If the requester is not identified (3), the connection to the requester does not occur (4) and the system shuts down (5) or returns to its standby mode. Alternatively, if the requester(s) are identified (3), the controller identifies the requester with the highest priority (6). The decision based on priority can have numerous parameters, but primarily would rely on time of the requested wakeup call. Afterwards, the controller instructs the PBX to initiate a call to the requester having the highest priority (7). If the connection is established (8), the PBX plays a prerecorded message (12) and the status of the requester is changed to “woken up.” (13). The system returns to step (2) to identify the next requester with the next highest priority (2). If the connection with the requester is not established (8), the status of the requester is noted (9), while the PBX attempts to reach the requester (10). If the controller found that not all attempts have been exhausted (10), the controller returns to the database to search for and retrieve another requester (2). If all attempts are exhausted, the status of the requester is updated to “unavailable” or “not called” (11), and the system returns to step (2). Alternatively, the controller can send the subscriber a message via email, SMS or other available communication techniques advising the requester that an attempt to wake him or her up was made but it was unsuccessful.

While the social interaction system has been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the appended claims. Just as successfully as the system can be used as a social alarm, the system can also be used for greetings, reminders, anonymous dating, and other pseudo virtual interactions.

The description provided herewith has not attempted to exhaustively enumerate all possible variations. That alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are hereby incorporated by reference in their entireties as if fully set forth in this specification.

We claim:

1. A system comprising:
a network wherein a plurality of communication devices have access to said network; and
an exchange system configured to receive a connection request from any one of said plurality of communication devices and initiate a connection between said communication devices;
the exchange system comprising:
a branch exchange configured to receive a connection request and initiate a connection between the communication devices once a match between subscribers has been identified;
a database of subscribers requiring a service, wherein entries corresponding to each one of said subscribers is further organized by a communication device employed, a contribution, a time of the service request, and a preference; and
a controller in communication with the database and the branch exchange, said controller configured to receive a request from the branch exchange about subscribers requiring the service for a given time and to search the database to identify said subscribers based on their contribution and preference; said controller further configured to instruct the branch exchange to initiate the connection between the communication devices once the subscribers are matched.

2. The system of claim 1, wherein the service is a wakeup, a greeting, or a reminder service.

3. The system of claim 1, wherein the branch exchange is a PBX.

4. The system of claim 1, wherein the exchange system further comprising an interface.

5. The system of claim 4, wherein the interface is web-based, text messaging-based or telephone-based.

6. The system of claim 1, wherein the preferences are selected from sex, age, location of the subscriber, language, interests, religion, political views, education, or a combination thereof.

7. The system of claim 1, wherein the communication devices access to the network by a land line or wirelessly.

8. A method of connecting two or more individuals anonymously, comprising:
contacting an exchange system by a provider at a prescribed time;
searching a database of the exchange system and identifying one or more requesters within providing an exchange system a time of a desired wakeup call for a requester;

9. The method of claim 8, wherein the step of providing the exchange system the time of the desired wakeup call of the requester further comprises providing a preference of the requester.

10. A method of connecting individual subscribers, comprising
loading a connection management system program into a RAM of a computing/call management device;
executing the loaded program;
providing status on availability of subscribers with outstanding service requests;
accepting a call from a calling subscriber who wants to provide service;
submitting a request to a controller of the connection management system to identify available subscribers who require a service within a predefined time window;
submitting a query to the database to check for previously installed service requests, which have not yet been linked to other subscribers;
obtaining the information from the database about the service requests;
verifying the availability of subscribers with a pending service request;
instructing a PBX to disconnect the calling subscriber if the service requests were not found;
identifying a subscriber who requires service with the highest priority if the service requests were found for the predefined time window and matching preferences;
instructing the PBX to initiate a call to the subscriber who requested service with the highest priority;
verifying whether the call is accepted by the requesting subscriber;
instructing the PBX to establish a connection between the calling subscriber and the requesting subscriber if the call is accepted by the requesting subscriber;
allowing the connected subscribers to communicate for a period of time;
after completing the call, initiating disconnection.

11. The method of claim 10, further comprising submitting the calling subscriber information into the system before submitting a query to the database.

12. The method of claim 11, wherein the calling subscriber information is required if the requesting subscriber has a preference.

13. The method of claim 12, wherein the preference is selected from the group consisting of opposite sex, same sex, similar age, regional background, interests (music, movies, sports, books and activities) and a combination thereof.

14. The method of claim 12, wherein if no service request are available, offering the calling subscriber an opportunity to be called back later by the system when a service request becomes available that matches the calling subscriber and the requesting subscriber preference.

15. The method of claim 10, wherein the step of instructing a PBX to disconnect the calling subscriber if the service requests were not found, further comprises
allowing the PBX to inform the system of the failed attempt;
verifying that the number of attempts is exhausted; and
submitting a request to the database to identify the available service requests, wherein the service request with the number of attempts exhausted are taken out of the pool of available service requests.

16. The method of claim 10, wherein providing status on availability of subscribers with outstanding service requests is made by means of a web site, a mobile application, an application for the internet-ready TVs or DVD/blue-ray playback devices, or a combination thereof.

17. The method of claim 10, wherein the calling subscriber calls the system by means of a mobile phone, a PC, a handheld computer, a radio, or a combination thereof.

18. The method of claim 10, wherein the system initiates a call to the calling subscriber who agreed to provide service for the requesting subscriber.

19. The method of claim 18, wherein the calling subscriber is also the requesting subscriber and the method further comprises verifying subscriber preference between two or more subscribers.

20. The method of claim 19, wherein the preference is selected from the group consisting of opposite sex, same sex, similar age, regional background, interests (music, movies, sports, books and activities) and a combination thereof.

21. The method of claim 19, further comprising instructing the PBX to initiate a call either to both subscribers simultaneously (parallel) or to call in sequence (serial) after each subscriber responds.

22. An apparatus comprising:
at least one processor; and at least one memory including a computer program code;
the at least one memory and the computer program code configured, with at least one processor, to load and execute the computer program code in the memory that, provides status on availability of subscribers with outstanding service requests;
accepts a call from a calling subscriber who wants to provide service;
submits a query to the database to identify available subscribers who require a service within a predefined time window and check for previously installed service requests, which have not yet been linked to other subscribers;
obtains the information from the database about the service requests;
verifies the availability of subscribers with a pending service request;
instructs a PBX to disconnect the calling subscriber if the service requests were not found;
identifies a subscriber who requires service with the highest priority if the service requests were found for the predefined time window and matching preferences;
instructs the PBX to initiate a call to the subscriber who requested service with the highest priority;
verifies whether the call is accepted by the requesting subscriber;
instructs the PBX to establish a connection between the calling subscriber and the requesting subscriber if the call is accepted by the requesting subscriber;
allows the connected subscribers to communicate for a period of time; and
after completing the call, initiates disconnection.

23. The apparatus of claim 22, wherein the apparatus initiates a call to the calling subscriber who agreed to provide service for the requesting subscriber.

24. The apparatus of claim 23, wherein the calling subscriber is also the requesting subscriber and the apparatus verifies a subscriber preference between two or more subscribers.

25. The apparatus of claim 24, wherein the preference is selected from the group consisting of opposite sex, same sex, similar age, regional background, interests (music, movies, sports, books and activities) and a combination thereof.

26. The apparatus of claim 24, further configured to instruct the PBX to initiate a call to both subscribers simultaneously (parallel) or to call in sequence (serial) after each subscriber responds.

27. A computer program comprising:
computer executable program code stored in a non-transitory computer readable medium, the computer program comprising:
computer executable program code configured to provide status on availability of subscribers with outstanding service requests;
computer executable program code configured to accept a call from a calling subscriber who wants to provide service;
computer executable program code configured to submit a request to identify available subscribers who require a service within a predefined time window;
computer executable program code configured to submit a query to the database to check for previously installed service requests, which have not yet been linked to other subscribers;
computer executable program code configured to obtain the information from the database about the service requests;
computer executable program code configured to verify the availability of subscribers with a pending service request;
computer executable program code configured to instruct a PBX to disconnect the calling subscriber if the service requests were not found;
computer executable program code configured to identify a subscriber who requires service with the highest priority if the service requests were found for the predefined time window and matching preferences;
computer executable program code configured to instruct the PBX to initiate a call to the subscriber who requested service with the highest priority;
computer executable program code configured to verify whether the call is accepted by the requesting subscriber;
computer executable program code configured to instruct the PBX to establish a connection between the calling subscriber and the requesting subscriber if the call is accepted by the requesting subscriber;
computer executable program code configured to allow the connected subscribers to communicate for a period of time; and
computer executable program code configured after completing the call to initiate disconnection.
